(19) United States
(12) Patent Application Publication
(10) Pub. No.: US 2023/0139584 A1
(43) Pub. Date: May 4, 2023

(54) Verifying the Metaverse

(71) Applicant: Wesley J. Boudville, Los Angeles, CA (US)

(72) Inventor: Wesley J. Boudville, Los Angeles, CA (US)

(21) Appl. No.: 17/300,770

(22) Filed: Nov. 2, 2021

(51) Int. Cl. G06K 9/00; G06F 3/01; G06Q 20/40; G07F 19/00; G07C 9/00

(52) U.S. Cl. CPC G06K 9/00671; G06F 3/011; G06Q 20/40; G07F 19/207; G06K 9/00906; G07F 19/206; G07C 9/00944; G07C 2009/00952; G07C 2009/00992; G06K 2009/00644

(57) ABSTRACT

We verify Metaverse users. You contact a user having an avatar. She goes in the real world to an area scanned by security cameras or drones. Or to an ATM. Or enters a building with a security camera. You see her images in the real world. You ask her to do manual actions in view of the camera, to verify she controls the avatar in front of you in the Metaverse. The tasks she does can be analyzed by image recognition and AI by a server, which tells you if she did these or not.

### TECHNICAL FIELD

Metaverse, Virtual Reality, Augmented Reality

### BACKGROUND

The Web has grown massively in over 30 years. Some 300 million domains exists and millions of websites. Plus there is a parallel group of mobile apps that run on mobile devices. So great has been this growth that it turned traditional hard copy newspapers, magazines and books into stunted poor relatives of their online counterparts.

Now typically, a magazine exists mostly in electronic form (usually as a PDF). Only in some cases is it considered desirable or necessary to make a printed version. And in this latter case, the PDF is merely printed out.

Separately, the Metaverse has gotten wide attention. It is a postulated future version of the Web. A Virtual Reality (VR) universe that goes far beyond what has been done by Second Life. The specific form that the Metaverse might take is under dispute by various parties. The term Metaverse originated in a science fiction novel Snow Crash by Neal Stephenson in 1992. In the Metaverse, humans use avatars to interact with each other.

### BRIEF DESCRIPTION OF THE DRAWINGS

FIG. 1 shows a hardcopy printed page with text and linkets.

FIG. 2 shows browsers that visit somewhere.com.

FIG. 3 shows 3 hardcopy flyers left at different parts of Los Angeles.

FIG. 4 shows the linket server and a camera server.

FIG. 5 shows images associated with hardcopy linkets being uploaded.

FIG. 6 shows the real world interacting with the Metaverse.

FIG. 7 shows a ranking of credences of different camera devices.

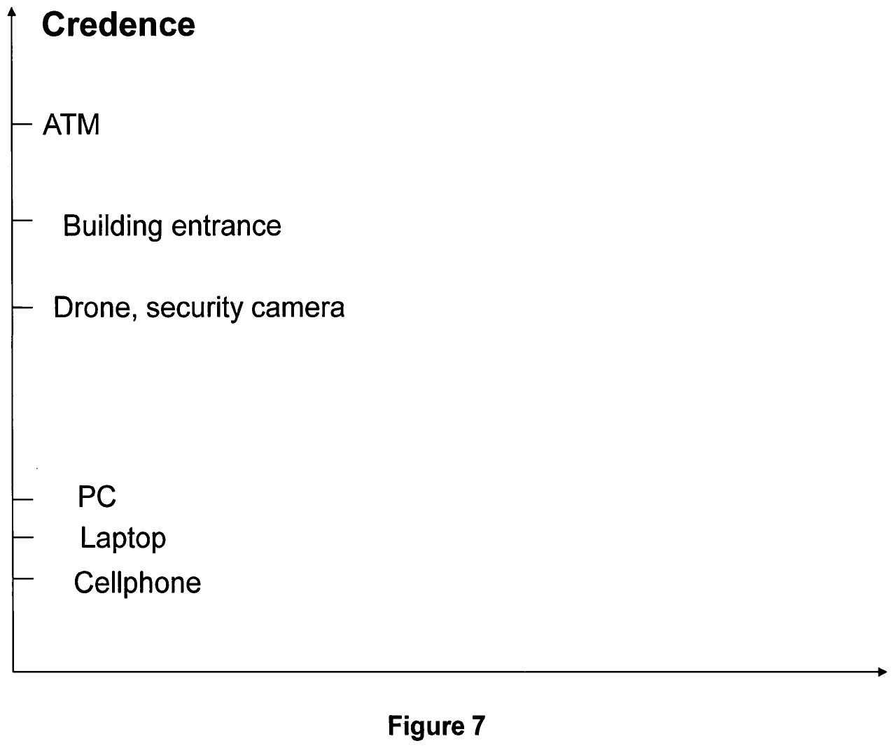

FIG. 8 shows automation to analyse an avatar and its human.

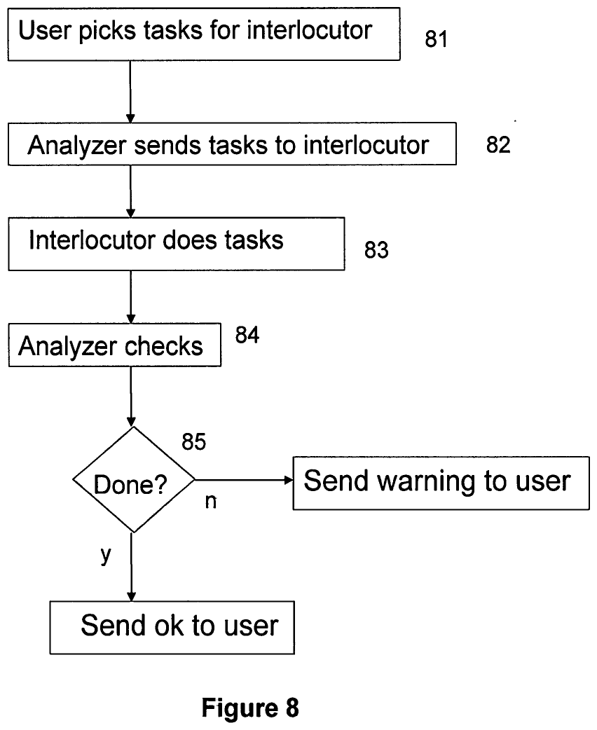

FIG. 9 shows types of interactions between avatars A and B.

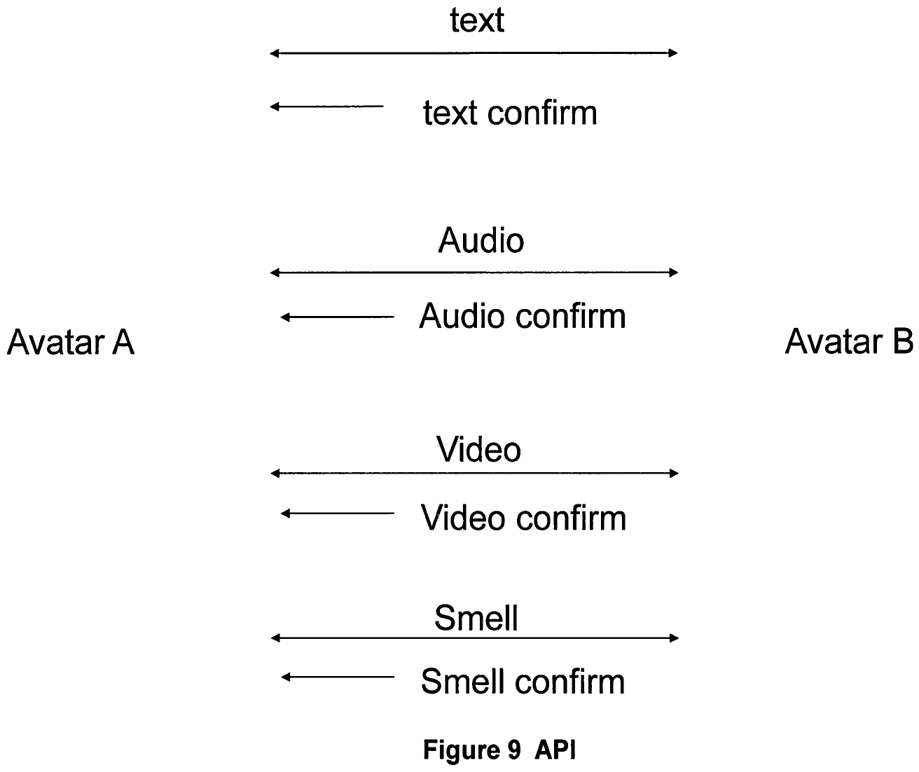

FIG. 10 shows a review of an avatar.

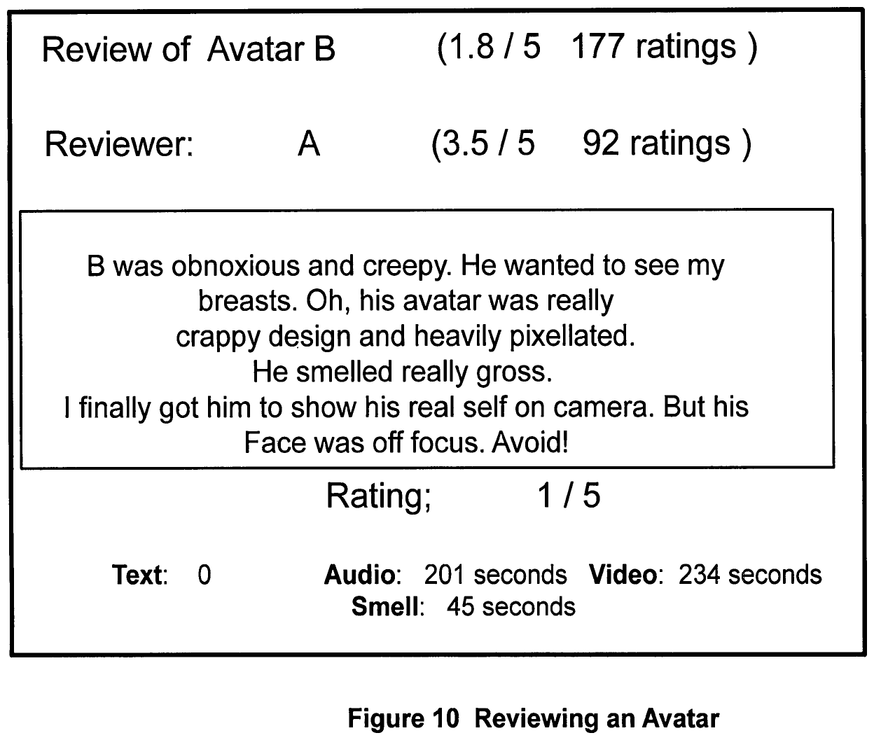

### REFERENCES

“Offline links to online data” by W. Boudville and A. Moskowitz, Ser. No. 17/300,641, filed 9 Sep. 2021.

### DETAILED DESCRIPTION OF THE PREFERRED EMBODIMENT

What we claim as new and desire to secure by letters patent is set forth in the following.

We use the term VR (Virtual Reality) in this application. For simplicity, this is taken to encompass Augmented Reality and Mixed Reality.

This application has the following sections:

1: Basics;

2: Using hardcopy linket;

3: Attack vectors;

4: Transient mobile geofence;

5: Propagating the brand;

6] Propagating multiple brands concurrently;

7] Metaverse;

7.1] Variants;

7.2] ATM machine;

7.3] Entering a building;

7.4] Credence;

7.5] Payment for camera use;

7.6] Automation;

8] Reviews;

9] Metaverse business;

1: Basics;

In an earlier application, we described how a “linket” like [Beta] is akin to a domain name. But the linket is printed on physical media, like a newspaper, flyer or book. (In some cases, the linket might appear as text on an electronic screen.) The linket is scanned by a mobile device's camera. The mobile device might be a cellphone. Optical Character Recognition (OCR) is used by the device to scan and decode the linket. Thus the physical [Beta] is converted to an electronic [Beta].

The latter is then sent to a linket server, which tries to map the linket to one of:

a) an URL (Universal Resource Locator). This leads to the URL being the address of a webpage. Here the linket is essentially competing with a domain name. The linket points to a webpage.

b) a deep link, consisting of an id of an app in a mobile app store, plus an Internet Protocol address (IPv4 or IPv6) of an instance of the app. The linket is pointing to a mobile device (at that IP address) used by the owner of the linket. The hardcopy linket was scanned by a user who now runs another instance of the app, this instance connecting to the instance run by the owner.

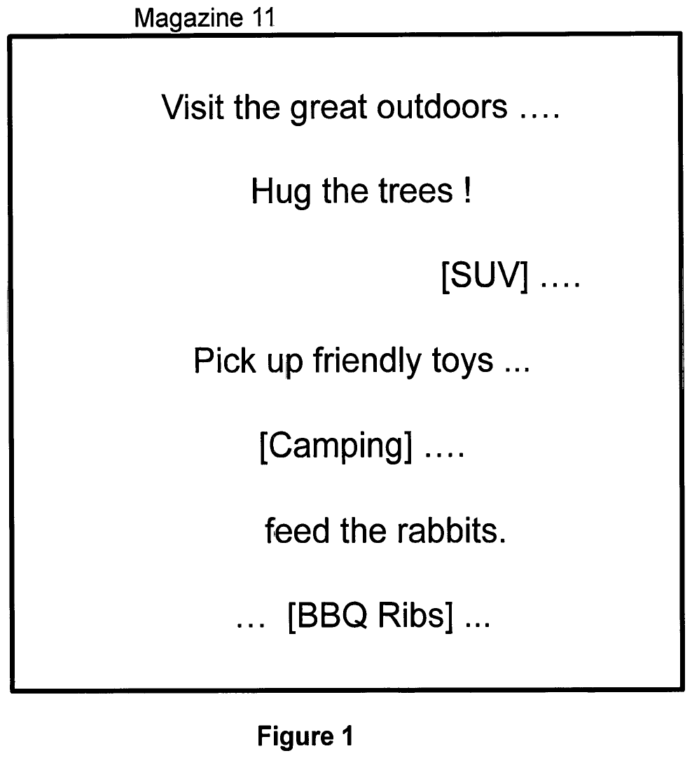

See FIG. 1.

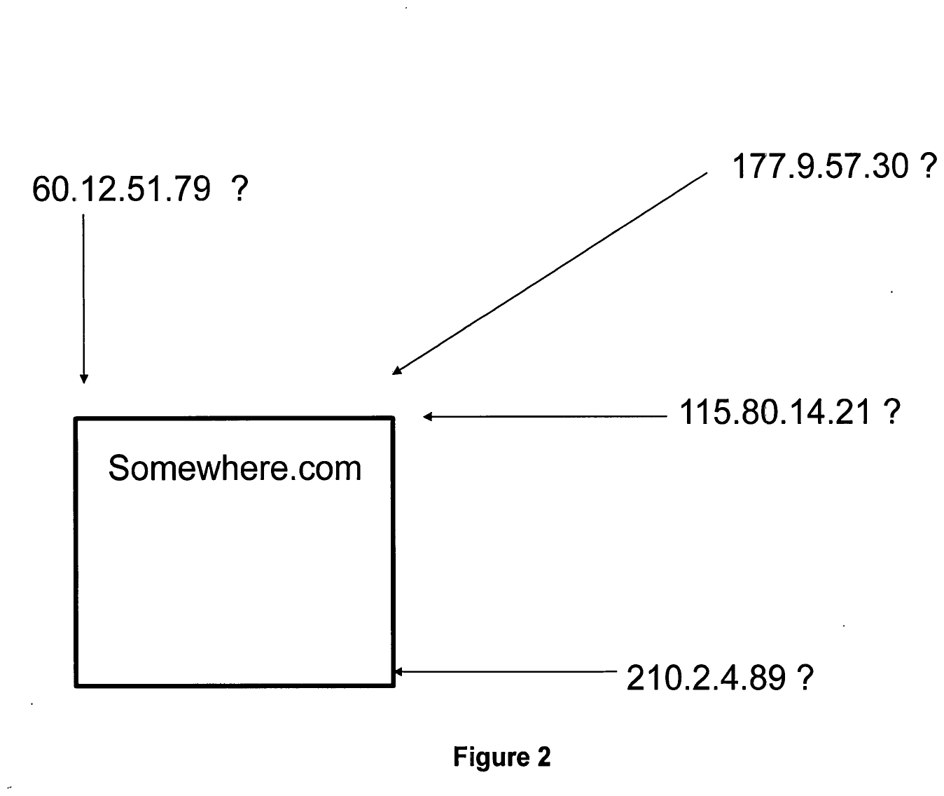

This application tackles a pervasive problem of click fraud. FIG. 2 shows the general case of a webpage at somewhere.com. The webpage comes from its web server and the latter can be at some specific and known latitude and longitude. On the web, browsers at arbitrary locations can go to somewhere.com and load a copy of the webpage. At the user level, FIG. 2 is the fundamental operation of the Web. It also leads to the fundamental problem. Browsers can be anywhere, both in terms of an Internet address and of a geographic location. FIG. 2 shows 4 hypothetical IP addresses of these browsers. The question mark by each signifies the unknown veracity.

For simplicity, only IPv4 addresses are used. But using IPv6 addresses does not change the argument.

Fraudsters have taken advantage by generating fake calls to the web server. The calls are not made by different humans who want to read the webpage, but by machines whose sole purpose is to gin up the number of browser clients who load the webpage. Structures like click farms have arisen for this means.

Countermeasures include trying to ascertain which of the Internet addresses of the browsers is valid. The addresses come from the server logs of the web servers. The reader can appreciate that this is very difficult. A common rough estimate is that half of the purported Web traffic is fake.

2: Using hardcopy linket;

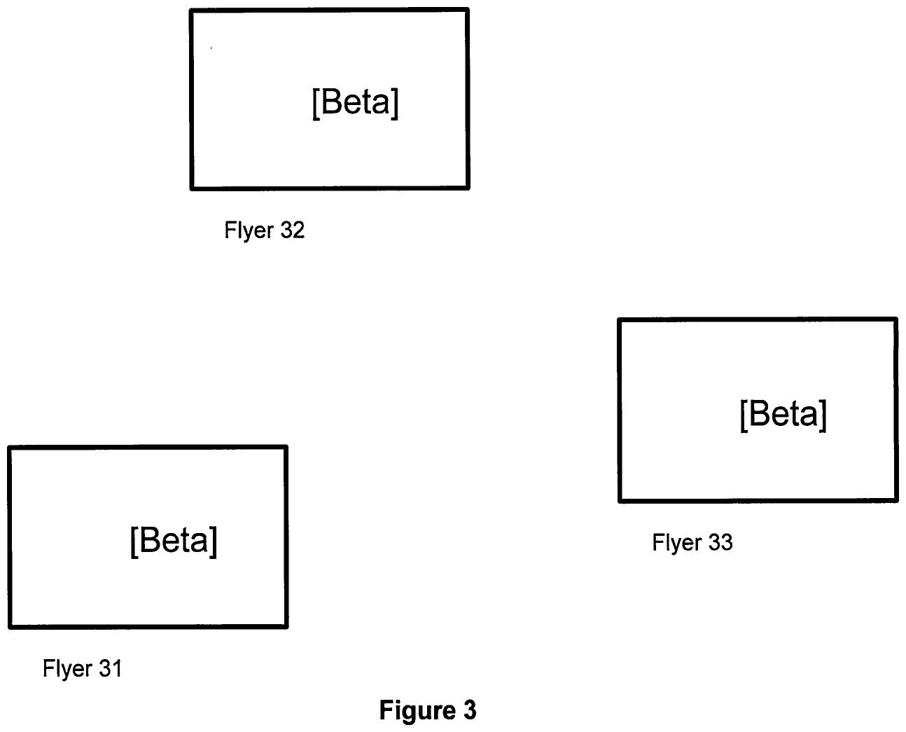

FIG. 3 shows 3 hardcopy flyers. Flyer 31 was placed in the suburb Culver City of Los Angeles. Flyer 32 was in the suburb Venice Beach of Los Angeles. Flyer 33 was in the suburb Playa Vista of Los Angeles. The flyers were placed in publicly accessible parts, like a bulletin board or magazine dispenser. Other than a general name of a suburb no attempt is made to record more precisely the location.

A deployment of hardcopy linkets would use more than 3 hardcopies. But it can be assumed that the hardcopies would appear in a given geographic region. Knowledge of this can be used with data from the scanning app, which can include the location of the user. Unlike the case in FIG. 2 of visitors to a webpage coming from arbitrary global locations.

As a practical aid, geofences can be used to define the regions in which the hardcopies are placed. If a region is a suburb, the chances are likely that the boundary of the suburb can easily be found online. For example, Wikipedia often has entries for well known suburbs of the US, and these might already have the boundary defined by a geofence. It can also be expected that over time, some databases will make such geofences accessible to online queries.

Plus. The organizer who distributes flyers might want to define more specialized regions by having to explicitly define an enclosing geofence.

Thus in FIG. 3, if the linket server were to find that the linket was scanned in Calgary or Topeka, that datum might be flagged as suspect. The datum might be correct. We can imagine a person from Calgary who visited Los Angeles and picked up the flyer. She did not scan it until she returned to Calgary. The advertiser who had the flyer printed might be thrilled. But our method can provide a cautionary note.

In the context of FIG. 2, our method lets us detect and perhaps flag as false the scanning of brands that appears outside the regions where the brands were printed as hardcopy.

A second issue is that we know a priori the number of hardcopies that existed initially. Suppose 1000 were printed and distributed in the above Los Angeles suburbs. A rough rule is that this gives an upper limit of 1000 scans by users.

Note that a flyer might be scanned several times, in principle. But in practice many flyers can be assumed not to be scanned. The 1000 (or a sub-multiple) can function as a de facto upper limit. This acts to further constrain the number of valid scans.

For websites, fraud often arises because a visitor can be anywhere on the Web, which means essentially anywhere on Earth. But the above lets us constrain the locations of those scanning a hardcopy linket and also the number of hardcopies. At the simplest level, our submission helps keep the data honest.

For a given region where the hardcopies were put, this can be in publicly accessible areas with surveillance cameras. One use of the latter is to record an overall crowd count, without having to necessarily identify those seen by the cameras. This count can be used to act against claims that a large crowd came and did many scans of the hardcopies, “thus” resulting in the equivalent of a large number of visitors to a website.

This idea can be taken further. In a given region, only some subareas need be surveilled intensively. Other areas in the region might not be recorded, even though these areas have cameras. The intent is that in a different time period, different subareas are randomly chosen to be surveilled. This makes it harder for an attacker to add false data claiming that x number of people scanned hardcopies in a subarea. Where the value of x is falsely inflated above some true number.

This uses a continuing trend for more deployment of cameras in public places. Some cameras are privately owned, often by the owners of the buildings on which the cameras are attached. Other cameras are owned by a government, who uses these as (eg) anti-terrorism measures. In either case, image recognition can be used to recognise people using their mobile devices to scan a flyer, newspaper, magazine (etc). From such analysis the owner can detect and count the number of people in an area who scan.

This hyper focus can be of value to the distributors of the hardcopies. The owner of the cameras might be able to count up the number of each sex who did the scans. It is well known in marketing that certain ads are directed just to women or just to men. Separate from checking on the veracity of the scans.

When a person scans a linket, the linket server knows in real time when this was done. The server can communicate this to the camera server, as well as telling the camera server where the scan took place. While the camera server might discard scans after some time, to reduce storage, the real time aspect means the camera server can be alerted while it still has video images stored in its memory or disk. The camera server can retroactively analyse the data using more intensive methods, to extract more demographic data. Plus, the camera server may be able to analyse the future actions of the person if she is still in the vicinity of the scanned hardcopy and the cameras.

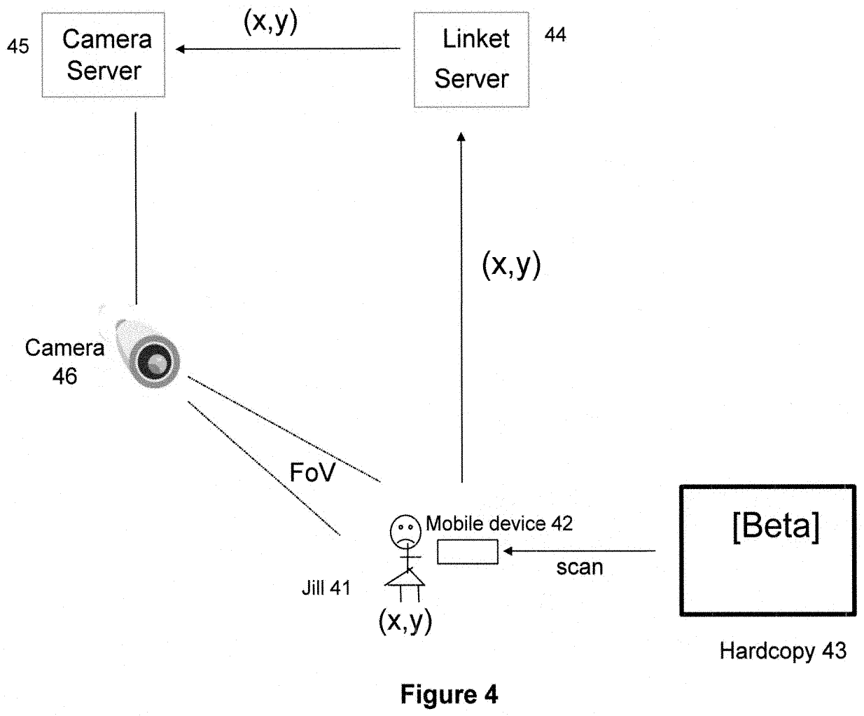

FIG. 4 shows a user Jill 41 with a mobile device 42. Typically the device will be her cellphone. She scans hardcopy 43, which has in the scanned text the linket, shown here as [Beta]. Her device 42 is at the location (x,y). Her device scans the hardcopy and either uploads the scanned image to linket server 44, or device 42 scans it to a digital [Beta]. In either case, linket server 44 ends up with a digital [Beta], and her location (x,y). The linket server 44 is in contact with the camera server 45 and sends (x,y) to the latter. Camera server 45 controls camera 46. Camera server 45 might control other cameras, but we assume that when the camera server gets (x,y), it has means of finding the closest appropriate camera 46. The camera might have to pan, tilt or zoom to bring Jill into its Field of View.

(This assumes the camera can do the operations of pan, tilt, zoom. Not every camera can do this. But with the increasing use of technology in cameras, this invention anticipates the increasing likelihood of functionality.)

Assuming that the camera has found Jill, the video or stills it takes are uploaded to camera server 45. The latter might also search its memory for previous stills or video of Jill.

The linket server can aid the camera server in finding the person who did the scan. From the digital linket that the linket server gets, it can work backwards in its database to find already stored images of the overall hardcopy that has the linket printed in it. For example, if the hardcopy linket appears in a newspaper ad, the linket server can have images of the front and back pages of the newspaper, even if the ad is in an inside page. Or suppose the newspaper has inside it a multipage brochure of ads. The linket ad might or might not be in that brochure. But the server can have images of the brochure. Or suppose the linket appears on 1 side of a 1 page flyer. If the other side is not blank, the server can have an image of it.

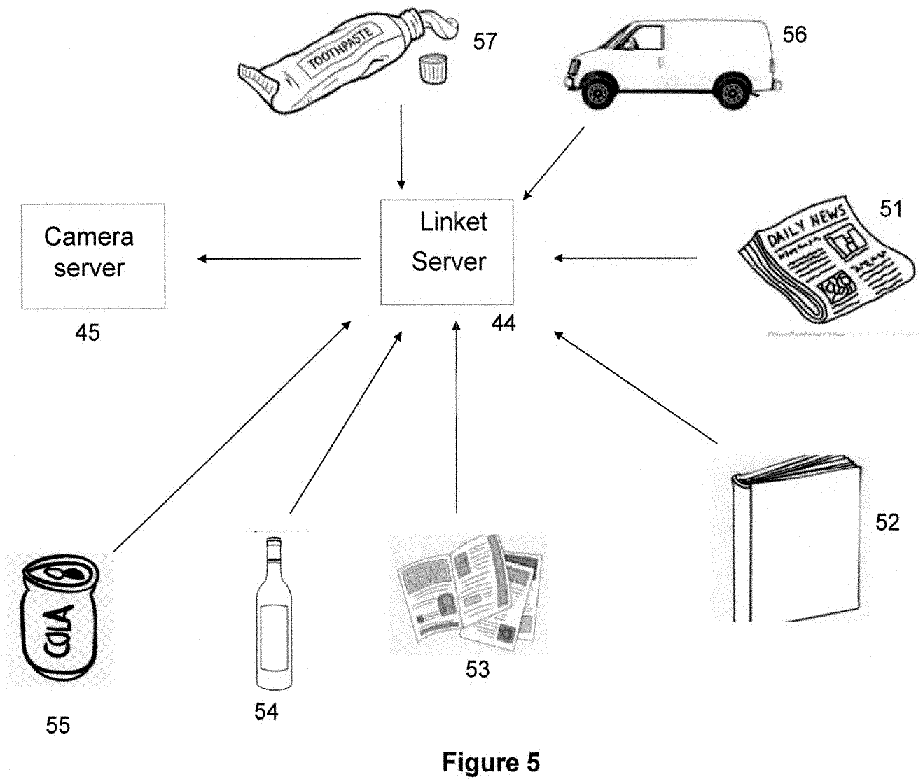

FIG. 5 shows this. Item 51 is images of a newspaper. The newspaper has a linket (or several) on 1 or more of its pages. The pages can be in the interior. The images taken include images of the front and back pages. Item 52 is images of a book (hardcover or paperback). The book has 1 or more linkets inside. The images in item 52 include images of the cover. Item 53 is a brochure or flyer.

Item 54 is a bottle of wine. The label on the bottle might be scannable. Item 55 is a soda can, on which there might be a logo that is scannable. The surfaces of the bottle and can are curved. But we anticipate that this will not present a problem to the scanning software having to deal with a logo or brand on a curved surface.

Item 56 is a van. On its side/s can be a logo scannable by people nearby, when the van is parked.

Item 57 is toothpaste. Its logo can be scannable.

For the bottle, soda, toothpaste, the uploaded images might be of a single item or perhaps a collection of these. The latter can refer to a context where the user who scanned a logo is at a grocer where many instances of an item are shown for sale.

The images in FIG. 5 are taken by a person working for the firm who made the hardcopy linkets. The images are uploaded to the linket server 44. The direction of the arrow going from this to camera server 45 means the latter is likely to have to try to recognise repeated instances of the images uploaded to the linket server. Thus for efficiency it is suggested that some or most of those images be sent to the camera server, where the image recognition is mostly or entirely done.

When the linket server sends such images to the camera server, the latter can now surveil to find a person near the location where a scan of the linket was done. This can help the camera server find to high confidence which person in its field of view did the scan.

If the camera server cannot find such a person, and especially if there are not many in the camera FoV, this is suspicious. Perhaps the “scanned” data that was sent to the linket server is false. It came from a cracker who is trying to gin up the hardcopy scan count.

The camera server can sell such aggregate statistical data to those who made the hardcopies. By suitably anonymising the data. The camera server can also sell video data. This data lets the marketers see what types of clothes the scanner person wears, and also their habits. What other stores nearby does she visit? Does she get a coffee from a national chain of coffeehouses or from an independent store? Does she go to a restaurant or bar? Does she go to a clothing store? The camera server can take precautions like fuzzying her face, to anonymize.

This can be taken further. The above described actions of private firms. But a societal advantage also accrues. The existence of the above methods means that if law enforcement is searching for terrorists it can access and even run these methods actively. Including not fuzzying suspects' faces.

The remarks above exploit a key aspect of fake data on website or, in our case, hardcopy linket use. The fakeness occurs in falsely inflating use, not in falsely understating use.

3: Attack vectors;

One possible attack vector against this invention is where a cracker might have a modded mobile app that does the scanning and uploading to the linket server. But this rogue app retains the scanned image. It might try to send the image to other devices under the control of the cracker. The intent is for those devices to somehow upload to the linket server and get the server to accept the uploads as genuine and thus inject false scans into the data.

A weak aspect of the attack is the locations they use. Suppose the cracker can remotely have his devices somehow pretend to be in the valid geofence. So each attack device can take on a location inside. If a device pretends to be at an (x,y), the linket server when it gets that (x,y) uploaded to it, can send it to the camera server for that location. The camera server can look just a short time after that supposed user scanned the hardcopy. The camera server will look for that user to be at or near the (x,y). It is reasonable to expect that some valid users, who are actually at an (x, y) to still be within proximity. The cracker's problem is that he likely has no devices and users actually inside the geofence.

When a camera server looks for a user at or near a (x, y), there might actually be 1 or 2, by coincidence. But unless the areas are crowded, sometimes there will be 0. If across the set of camera servers, the latter is often observed, it can be taken as strongly suggestive of fake locations.

But there is a stronger countermeasure we can take. The camera servers are assumed to have video stored of the immediate past around an (x, y). Eventually we can expect a datum to happen at an (x, y) and at a time when the video evidence says there was no one there. This is strong evidence of an attack.

The cracker might respond by putting his (x, y) locations in places with no camera oversight. This assumes he has a means of finding such places, which might be a non-trivial problem if he is outside the country. In turn, if the linket server finds that many of the locations are in the geofence but outside the purview of cameras, that can be used as an indicator of an attack.

Related to this is that the distribution of hardcopy might be preferred to happen in areas under camera surveillance. This puts further pressure on the cracker as his locations outside those areas will stand out more.

The above leaves the case where the cracker has his devices pretending to be in areas under the cameras, and at times when the areas are crowded. Here, the cameras need to be using image recognition advanced enough to detect whether a hardcopy linket was scanned or not.

4: Transient mobile geofence;

Look at item 56 in FIG. 5. It is a van that can have a logo on 1 or more of its sides. The van shows a key point. It is mobile. It might be driven to a given location and parked. Letting people nearby scan its logo. There might be a geofence around the van's current location. Then the van is driven to a different place and now a new geofence is made.

Suppose the van does not give away hardcopy instances of its logo. Then when the van moves from its present (x, y) there is no means for a user near that place to scan the logo. Previously we discussed where nardcopy instances of a linket/logo are left at a place. So the geofence around that place could persist for some time. But in this section, the geofence can terminate a short time after the van has driven away.

The transient aspect can have deliberate marketing significance. It acts an inducement for people nearby to act on the brand. To scan it now.

5: Propagating the brand;

Thus far, we focused on correctly counting actual scans made by users near hardcopy instances of the brand. But the rise of social media on the Web has shown the importance of how this can affect the impact of a brand. The problem has been its abuse, with rampant over counting due to the introduction of fake data.

One answer in this section is to let a user who scanned a hardcopy brand be able to forward it to others. Consider user Jill who did so via the scanner app on her mobile device. The app can let her forward this to other users via common techniques like sending to users in her address book. The actual sending can be done via email, Twitter, instant messages etc. The linket server (which is the server for her scanner app) is tasked with keeping the record of the users who did actual scans of hardcopy. The amount of data on each user can depend on the implementation of the server. And for a given implementation, this can vary with the user.

6] Propagating multiple brands concurrently;

Hitherto we discussed 1 brand being publicised at a time in hardcopy. But in practice several brands will be done as such concurrently. Imagine the owner of [Beta] doing so, and the owners of [Soda] and [Fries] doing likewise at the same time. Each owner prints up different numbers and types of hardcopy and disseminates them independently. Suppose they do so in the same geofence. Each contacts the linket server and tells it the information about the owner's brand. This information also includes data described about (eg) the newspapers or brochures in which the hardcopies are printed or exist as leaflets.

Now consider 1 area inside the geofence, where hardcopies for all 3 brands exist near each other. This area is assumed to be under surveillance by cameras controlled by a camera server. There might be magazine or flyer racks where these are put by people employed by the brands to do so. As people (potential customers) go by, several might stop and perhaps take and scan a hardcopy.

In a period of time, the linket brand server might get several requests for [Beta], [Soda], [Fries]. The brand owners will want to verify these with the camera server, as described earlier. One issue is where the camera server gets several requests from the linket server to try to find more information about those who scanned the brands in the immediate past. The camera server has 2 problems. How to decide which camera gets which tasks. (Assuming the server controls several cameras.) And for each camera, how to partition its time to find the users who scanned brands at different locations.

Roughly, the camera server might group the tasks by the locations of the users. It would be more efficient for a camera to look for users who were near each other. And broadly, the distribution of locations is split into groups, each group being closer to its mean/median than to other groups, ideally. Readers familiar with numerical analysis will see that this can be intricate.

The efficiency for a camera comes in each camera having to change its orientation (pan, tilt and zoom) by minimal amounts to scan for each user in its group, if the group is well defined and separate from other groups.

An issue arises. If the cameras and their server are busy, they can let the brand owners bid for priority use of the camera and server resources.

7] Metaverse;

A Metaverse might find it useful to have verifiable connections to the real world. Thus our earlier specification and the earlier parts of this specification talked about a different onramp to the Web. This uses hardcopy brands we call linkets. When scanned by a mobile app that does OCR, the brand is converted to electronic form. This can be mapped by a brand server to an URL pointing to a website.

This section generalizes. A problem with a current discussion of the Metaverse that talks about humans using avatars to interact in the Metaverse is that it is too broad. We discuss a problem that will recur. Consider Jill in the real world who has a VR avatar. She uses it to interact with avatars and non-avatars in the Metaverse. Suppose she does so with an avatar run by Bill, who too is in the real world. He wants a simple indication of Jill's identity. He does not necessarily even need to know her real name. Maybe he just wants to know if Jill is a person and not a software or hardware construct.

There has been increasing concern recently about false users on social media and their posting of controversial comments on the Web. If the Metaverse were to become popular, it would be useful to have ways to verify if necessary users and their actions. Our invention offers a societal good to this effect, as explained below.

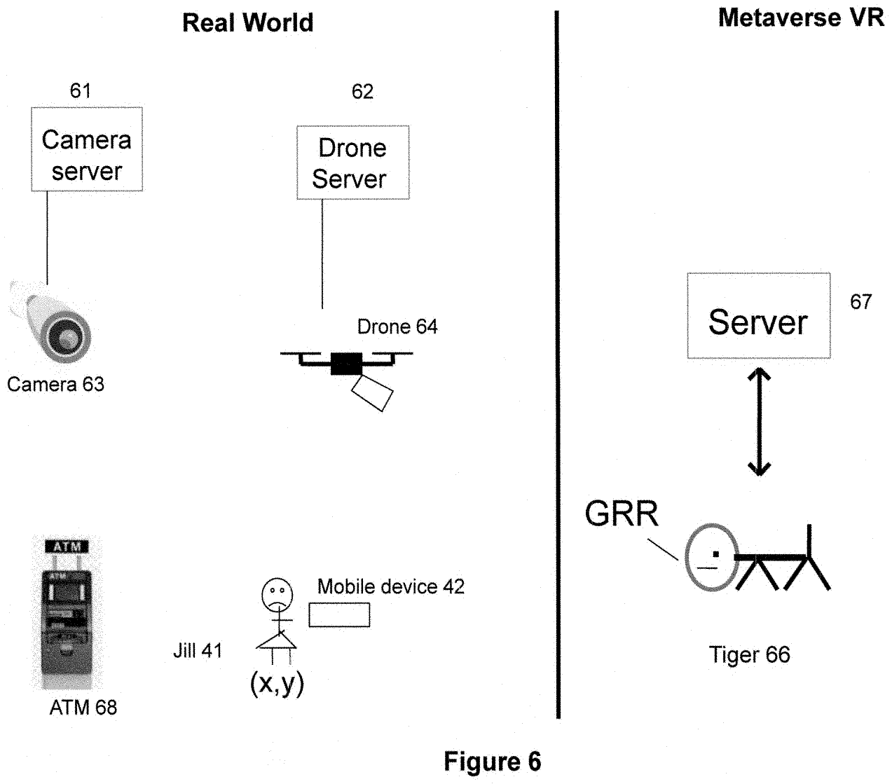

FIG. 6 shows the real world and the Metaverse. In the latter, Jill has the avatar tiger 66. This interacts with server 67. We will use the latter as a proxy for Bill.

In the real world, Jill 41 is at the real location (x,y). She has a mobile device 42. She uses this to control tiger 66. Or she might interact with some computer (not shown) that lets her control tiger 66. Near Jill is camera 63 controlled by camera server 61. Also near her is drone 64 with camera 65. Drone server 62 controls the drone. In the figure, the vertical line between camera server 61 and camera 63 is meant to indicate a communication link, which can be wired or some combination of wired and wireless. Similarly for the vertical line between drone 64 and drone server 62. As expected, this is wireless, or some combination of wireless and wired.

Servers 61 and 62 are linked to the Internet and ultimately interact with the servers of the Metaverse. There is an implicit connection between server 67 and 61 and 62.

Jill is assumed to have her mobile device be able to communicate her (x,y) to the camera server and the drone server, such that they can bring her into the Field of View (FoV) of their cameras. Or for camera 63, if it is in a fixed position, Jill might have to stand or walk near it. For camera 63, an app on her mobile device can use this property of the fixed camera to make a path that Jill can walk or drive to reach the camera.

There is an implicit connection between Jill's mobile device and tiger 66.

Server 67 is a catchall for tiger to interact with Bill's avatar or with some generic server having a presence in the Metaverse.

Bill can do the following to get some proof that Jill controls tiger. In general, we assume that Bill and Jill do not interact directly in the real world. And they are assumed not to know each other's email address or any other type of electronic address in the real world.

Bill asks Jill for a real time video interaction with her in the real world. She complies by having camera 63 or camera 65 bring her into their FoV. Their images or video are transmitted to server 67 and thence to Bill outside the Metaverse. It can be seen that the images go from the real world cameras to some Metaverse servers and then out of the Metaverse to a computer that shows these images to Bill. A reader can imagine an optimising step where the images from the cameras might never enter the computers of the Metaverse, but go more directly to a computer outside the Metaverse that shows them to Bill.

We attempted to offer clarity in FIG. 6 by omitting explicit links between devices in the real world and those in the Metaverse.

Bill looks at the images (which can include video). But at this point, all he is seeing is some female stranger. Purportedly the latter is Jill. He wants more proof that Jill 41 is the person he is interacting with inside the Metaverse. He asks Jill raise her right arm 3 times. Or do some other physical action that she would not normally do, and which can been easily seen by 1 or more of the cameras focused on her. This asking of Jill can be done via Bill's interaction with tiger, in the Metaverse. Or more directly outside the Metaverse by Bill and Jill having a separate channel because of how they set up their interaction. The asking can be an audio request. Or a text request. Or a video request.

Jill raises her arm 3 times. Bill sees this. Now this does not prove that Jill 41 is the person Bill is interacting with in the Metaverse. There could be an intermediary who controls tiger, and which relays Bill's commands to Jill. (A benign Man In The Middle scenario.) But for some if not many general interactions, this may suffice to Bill.

The point is that for general interactions in the Metaverse that are non-financial, this method can suffice. There is no need here for any explicit public key method, though such methods might be used at a lower level to guard against eavesdroppers. The simplicity of our steps can increase impetus for building out the Metaverse, by letting users have an easy way to empirically verify each other. Just as the proposed appeal of VR is the visual aspects on the interaction in the Metaverse, we flip this around. Our method uses the visual aspects of a complementary interaction in the real world.

The real time video interaction also is harder to simulate than the polished CGI interactions in recorded films. Film companies have render farms which are essentially small data centers. These do ray tracing type renderings to produce images that are photorealistic. But currently these cannot be done in real time.

We stress that the methods of this specification do not preclude using harder modes of identity verification. Like using digital versions of a passport, US social security number, Australian tax file number, UK NHS number etc. Those methods can be overlaid on ours.

The method whereby a user Bill tests the reality of user Jill do not have to be done every time they meet in the Metaverse. Bill might only do this occasionally. (Maybe even just once, when they meet for the first time.) And what we describe here for Bill testing Jill can apply symmetrically for Jill to do similar tests on Bill.

7.1] Variants;

We gave an example above where Bill asks Jill to raise her right arm 3 times. Bill asks directly her avatar tiger thru software in Metaverse. To aid Bill the software can have pre-defined options, like which arm Jill would use, and how many times.

Plus, when (presumably) Jill does this at the real world (x,y), the cameras capturing this can run AI or image recognition software to determine as automatically as possible what actions were done. A step further is that this determination can be compared against the instructions given to her. It simplifies what Bill decides and sees.

A refinement is that for the actions that Jill did incorrectly, Bill is told of these, and he can decide to let the software tell Jill what was not done correctly, so that she can retry these.

A refinement of the previous paragraph is where the set of commands she did wrong is automatically told to her and she can retry. So only if she fails this second time will Bill be told. This reduces the cognitive load on him.

A possible arms race can be predicted as software to make realistic but fake images of humans and their motions improves. One possible risk of having software that lets Bill decide from a menu of actions for Jill to do is that this gives a roadmap for attackers to develop fake images against.

A variant is for the camera used to image Jill to have hyperspectral ability. It can see in the near, mid and far infrared and also in the ultraviolet. This can be used to perhaps guard against a breakthrough in fake imagery, if the latter is mainly in the visible spectrum. In CGI, most of the computational effort to make an image from scratch is done in the visible spectrum. There is no need to do so elsewhere. If hyperspectral imaging is done and little is seen in the IR or UV of a purported human, this suggests that the image is purely computational and not a real image.

Having a hyperspectral camera also guards against an attack where an image is played on a flat screen and shown to the camera. To fool the camera that the image is purportedly a 3d object in the real world. It can be difficult for a camera with a fixed location and orientation to detect this. Unless the camera is hyperspectral.

For the cases of the last 2 paragraphs, the detection of these by the imager can be a high value target. If the user has gone to the trouble of doing such an elaborate attack, this should be promulgated widely as soon as possible. The Metaverse might have a virtual place where such detections of a bad avatar (and user) are posted. An analogy is that this is akin to detecting a phishing attack in emails.

A variant is suppose Jill is with a friend Dinesh, and he has an avatar in the Metaverse of a parrot. And his avatar is next to Jill's avatar. Bill might ask Dinesh to do jumping jacks in the real world in front of the cameras. In some cases, Dinesh does this before Jill does her actions. In other cases she goes first. In other cases they do these at the same time. In general Bill can decide in which order the actions happen.

A variant of the previous paragraph is where Dinesh is not physically near Jill, though their avatars are. This can be handled by a simple extension of the earlier steps.

7.2] ATM machine;

An important variant is where 1 instance of camera 63 is the camera in an Automated Teller Machine. Jill might authorize an ATM where she has inserted her bank debit or credit card, to transmit video of her. This video by explicit design of the ATM, focuses on her face. (The video omits showing which buttons she pushed for her code.) The point is that the video can show her withdrawing money from the ATM. The high threshold for this can add credence to visuals about her. See item 68 in FIG. 6. She might just choose to withdraw the minimum.

After Jill uses her card to log into the ATM, there can be an option for the ATM to transmit a video of Jill to some URL. Sending video to the latter will let Bill interact with her. Jill's phone can have some way to make that URL. But how does she get the URL to the ATM?

The most direct way is to have Jill type the URL on the ATM keypad. But this is fraught. Each key is a source of error. Instead, the app on her mobile device that she is using to interact with Bill can convert the URL to a barcode that appears on her phone screen. On the ATM screen is an option that she can just press, either on the ATM screen or on the keypad. This means if she holds up her screen to the ATM camera, it will take a photo of the barcode and decode the barcode to extract the URL. And then open a channel to Bill.

This method of opening a channel from Jill to Bill is essentially the same as when Jill uses a camera on a building or a drone to interact with Bill.

Instead of withdrawing money, the video could show Jill depositing money into the ATM. While not every ATM allows this, many new ATMs increasingly have this ability.

Most if not all ATMs have an ATM server nearby. For brevity the latter was omitted from explicit inclusion in FIG. 6.

For future ATMs, this section can be an added inducement for customers, or premium customers. (Those with high balances at the bank.)

She might use another camera to show her performing the earlier steps for Bill.

We claim:

1. A system of a first user in a virtual reality Metaverse verifying a second user in the Metaverse;
where the first user has a first avatar in the Metaverse;
where the second user has a second avatar in the Metaverse;
where the first user has a bidirectional video interaction with the second user;
where the video purportedly depicts the second user in the real world;
where the first user sends commands to the second user;
where the first user sees the second user do the commands;
where the first user judges the actions of the second user;
where the first user verifies the second user.

2. The system of claim 1,
where the first user sees video images of the second user taken by a security camera outside a building.

3. The system of claim 1,
where the first user sees video of the second user taken by a nearby drone.

4. The system of claim 3,
where the mobile device of the second user summons the drone to the current location of the mobile device.

5. The system of claim 1,
where the second user logs into an Automated Teller Machine (ATM);
where the second user picks an option on the ATM to transmit video from the ATM to the first user, at an URL of the first user;
where the mobile device of the second user converts the URL to a barcode on a screen of the mobile device of the second user;
where the screen of the mobile device of the second user is shown to the ATM camera;
where the ATM camera scans the barcode;
where the ATM decodes the barcode to the URL;
where the ATM opens a channel to the URL;
where the first user sees video of the second user taken by the ATM.

6. The system of claim 5,
where the first user sees video from the ATM showing the second user withdrawing or depositing money.

7. The system of claim 1,
where the first user sees video of the second user taken by a security camera inside a building, after the second user enters the building.

8. The system of claim 7, where the video shows the second user using a mechanical key or a key card to enter the building.

9. The system of claim 7, where the video shows the second user signing in a log book at a front desk of the building.

10. The system of claim 7, where the video shows the second user interacting with a security guard at a front desk of the building.

11. The system of claim 1,
where the first user picks one or more commands from a menu;
where the menu is made by a program used by the first user to interact with the second user.

12. The system of claim 11,
where the program uses image recognition to analyze the second user performing the commands;
where the program finds that the second user has correctly performed the commands;
where the program tells the first user.

13. The system of claim 11,
where the program uses image recognition to analyze the second user performing the commands;
where the program finds that the second user has incorrectly performed one or more commands;
where the program tells the first user which commands the second user did not correctly perform;
where the first user informs the second user;
where the second user retries the failed commands.

14. The system of claim 11,
where the program uses image recognition to analyze the second user performing the commands;
where the program finds that the second user has incorrectly performed one or more commands;
where the program tells the second user which commands the second user did not correctly perform.

15. The system of claim 14,
where the second user retries the failed commands;
where the program analyzes the retries;
where the program informs the first user of the results of the retries.

16. The system of claim 1,
where a device performs hyperspectral imaging when taking the video of the second user;
where the image is found to be missing parts in the infrared or ultraviolet;
where the device tells the first user that the image is not of a live person;
where the device posts a warning about the avatar of the second user, and the second user, to the Metaverse.

17. The method of claim 1, where the second user pays a fee to an owner of a camera used in the verification of the second user.

18. The method of claim 17, where the duration of verification exceeds a threshold;
where the first user pays a fee to the owner.

19. A method of a first user reviewing an avatar and a second user of the avatar on the Metaverse,
where an interaction is reviewed for aspects of text, audio, video, smell in the Metaverse;
where the interaction is reviewed for aspects of text, audio, video, smell in the real world;

20. The method of claim 19, where a smell interaction in the Metaverse is made by odor components being sent from a computer of the second user to a computer of the first user;
where the computer of the first user converts the odor components to an output odor experienced by the first user.
